(19) United States
(12) Patent Application Publication
(10) Pub. No.: US 2016/0077974 A1
(43) Pub. Date: Mar. 17, 2016

(54) ADAPTIVE CONTROL OF WRITE CACHE SIZE IN A STORAGE DEVICE

(71) Applicant: Seagate Technology LLC, Cupertino, CA (US)

(72) Inventors: Jun Cheol Kim, Seongnam-si (KR); Hye Jeong Nam, Yongin-si (KR); Sang Yeel Ji, Suwon-si (KR)

(21) Appl. No.: 14/484,616

(22) Filed: Sep. 12, 2014

(51) Int. Cl. G06F 12/08

(52) U.S. Cl. CPC G06F 12/0893; G06F 12/0891

(57) ABSTRACT

Technologies are described herein for adaptively controlling the size of a write cache in a storage device based on the time required to flush the cache. Upon receiving a write command at a controller for the storage device, an estimated cache flush time for the write cache is calculated based on the write commands contained therein. If the estimated cache flush time is greater than a maximum threshold time, the size of the write cache is decreased to control the cache flush time. If the estimated cache flush time is less than a minimum threshold time, the size of the write cache is increased to enhance random write performance.

### BRIEF SUMMARY

The present disclosure relates to technologies for adaptively controlling the size of a write cache in a storage device based on time required to flush the cache. The technologies may be implemented in a storage device, such as a hard-disk drive (“HDD”) device, that implements a write cache to improve writing performance. According to some embodiments, when a write command is received at a controller for the storage device, an estimated cache flush time for the write cache is calculated based on the write commands contained therein. If the estimated cache flush time is greater than a maximum threshold time, the size of the write cache is decreased to control the cache flush time.

According to further embodiments, a system comprises a storage device comprising a recording medium, a write cache for temporarily storing write data received for the storage device before processing, and a controller for processing the write commands. The controller is further configured to calculate an estimated cache flush time for the write cache and determine whether the estimated cache flush time is greater than a maximum threshold time. If the estimated cache flush time is greater than the maximum threshold time, the controller decreases a maximum write cluster count indicating a number of write commands that may be stored in the write cache. If it is determined that the estimated cache flush time is not greater than the maximum threshold time, the controller determines whether the estimated cache flush time is less than a minimum threshold time, and, upon determining that the estimated cache flush time is less than the minimum threshold time, increases the maximum write cluster count.

According to further embodiments, a computer-readable medium comprises processor-executable instructions that cause a processor operably connected to a storage device to, upon receiving a write command for the storage device, calculate an estimated cache flush time for a write cache for the storage device. If the estimated cache flush time is greater than a maximum threshold time, the processor decreases a maximum write cluster count indicating a number of write commands that may be stored in the write cache. If the estimated cache flush time is less than a minimum threshold time, the processor increases the maximum write cluster count.

These and other features and aspects of the various embodiments will become apparent upon reading the following Detailed Description and reviewing the accompanying drawings.

### BRIEF DESCRIPTION OF THE DRAWINGS

In the following Detailed Description, references are made to the accompanying drawings that form a part hereof, and that show, by way of illustration, specific embodiments or examples. The drawings herein are not drawn to scale. Like numerals represent like elements throughout the several figures.

FIG. 1 is a flow diagram showing one method of for adaptively controlling the size of a write cache in a storage device based on the time required to flush the cache, according to embodiments described herein.

FIG. 2 is a block diagram showing an illustrative environment for adaptively controlling the size of a write cache in a storage device based on the time required to flush the cache, according to embodiments described herein.

FIG. 3 is a block diagram showing an illustrative write cache containing multiple write commands, according to embodiments described herein.

FIG. 4 is a flow diagram showing another routine for adaptively controlling the size of a write cache in a storage device based on the time required to flush the cache, according to embodiments described herein.

### DETAILED DESCRIPTION

The following detailed description is directed to technologies adaptively controlling the size of a write cache in a storage device, such as a hard-disk drive (“HDD”) or solid state hybrid drive (“SSHD”), based on time required to flush the cache. To increase the writing performance of the device, an HDD or SSHD may implement a write cache in a fast memory system, such as a dynamic random-access memory (“DRAM”). For large sequential write commands, a typical HDD may be able to cache the commands up to the size of the DRAM cache. However, for random write commands, the access time required to process the commands may be much greater due to head seek time, rotational latency, and the like. The number of write commands allowed in the write cache may be limited to avoid aborted writes that may occur due to sudden power loss before the write cache can be completely flushed to the recording media.

As the size of the memory allocated to the write cache in devices grows, the time for flushing the cache (i.e., processing all of the write commands contained therein) also increases, thus increasing the chance of encountering the aborted writes due to sudden power loss. Several factors may affect the time needed for processing a write command in a storage device. Access time for the target location on the recording media for a particular write command may vary based on seek time of the read/write head, time for the recording medium to complete a full rotation (referred to herein as rotational latency), and the like. In addition, different types of write commands may require differing times for processing. For example, write-verify commands require at least one additional disk rotation in an HDD device over random write commands, while read-modify-write (“RMW”) commands may similarly require additional rotation(s) and/or processing time in the storage device. In addition, technologies such as rotational position reordering (“RPO”) and the like may be utilized to reduce the time required to process multiple write commands in the write cache.

For example, if the disk rotation time in a typical HDD device is 11 ms and the maximum seek time is 21 ms, the average access time may be approximately 16 ms. If the size of the write cache memory of the HDD is 32 MB and the size of data in a random write command is 4 KB (8 sectors*512 bytes each), the write cache of the device disk drive may be able to handle 8192 write commands. However, if 8192 write commands were to be stored in the cache, the cache flush time may be as high 131 seconds (8192 commands×0.016 seconds). If the write commands comprise a mixture of random writes commands, write-verify commands, and RMW commands, the cache flush time may be further increased.

Device manufacturers may desire to keep the cache flush time below a particular threshold, such as 3 to 5 seconds, at all times to both allow for fast power down cycles of host computers containing the devices and to minimize chances of aborted writes. Accordingly, a maximum write cluster count indicating a maximum number of random write commands that may be cached in the write cache may be set to control the cache flush time and keep it under the desired threshold. The maximum write cluster count may be set conservatively to a small number based on the worst possible scenarios, such as having combined write-verify and RMW commands in each operation. However, when the number of cached write commands is limited, the overall random writing performance of the drive may be severely degraded. Moreover, when the processing of random writes in a typical HDD device is analyzed, it is found that write-verify and RMW combined operations rarely occur and seek times often wind up being below the calculated average through the use of RPO and other optimizations.

According to embodiments described herein, a write cache mechanism may be implemented in a storage device in which the maximum write cluster count may be adapted in real time according to an estimated cache flush time of the write cache. The estimated cache flush time may be calculated for the write commands currently in the write cache based on various factors that affect the time for completion of the individual commands, such as command type (e.g., RMW, write-verify, etc.), estimated access time, RPO and other optimizations, and the like. The estimated cache flush time may further be based on other device conditions, such as temperature, shock, power conditions, and the like. If the estimated cache flush time is greater than the desired threshold value, the maximum write cluster count can be decreased to reduce the cache flush time, thereby reducing the possibility of aborted writes.

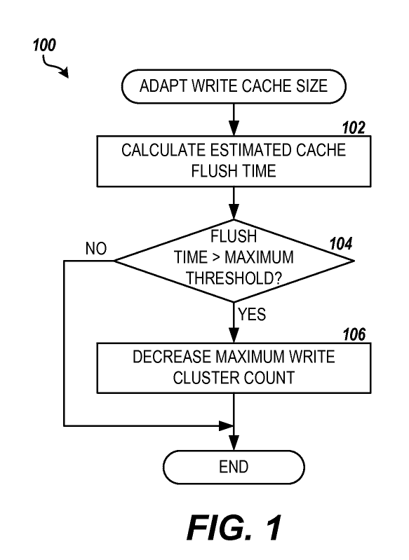

FIG. 1 illustrates one routine 100 for adaptively controlling the size of a write cache in a storage device based on time required to flush the cache, according to some embodiments. The routine 100 may be performed when processing write requests in a storage device implementing a write cache, for example. According to some embodiments, the routine 100 may be performed by a controller of the storage device.

The routine 100 begins at step 102, where an estimated cache flush time for the write cache is calculated based on the write commands currently in the cache. The estimated cache flush time may be calculated based on various factors of the write commands that affect the time required for the command to complete, such as the seek time and rotational latency, the type of write command being processed (e.g., random write, write-verify, RMW, etc.), and the like. In some embodiments, the calculation of the estimated cache flush time may also be based on other device conditions, such as temperature conditions, shock or noise environment, power conditions of the device, and the like.

From step 102, the routine 100 proceeds to step 104, where it is determined whether the estimated cache flush time is greater than a maximum flush time threshold. According to some embodiments, the maximum flush time threshold may be set at design time of the storage device, based on manufacturer or customer requirements for example. In some embodiments, the maximum threshold time may be between 3 and 5 seconds. In further embodiments, the maximum threshold time may be adjusted based on current conditions of the storage device, as will be described below. If the estimated cache flush time is greater than the maximum threshold time, the routine 100 proceeds from step 104 to step 106, where the maximum write cluster count is decreased. According to some embodiments, the maximum write cluster count may be decreased gradually while the estimated cache flush time remains above the maximum threshold time. For example, the maximum write cluster count may be reduced by a pre-defined value, such as 5, each time a write command is received and it is determined that the estimated cache flush time exceeds the maximum threshold time.

By reducing the maximum write cluster count when the estimated cache flush time is greater than the threshold, the cache flush time may be controlled while allowing a more liberal default maximum write cluster count to be used with the storage device, thus improving overall random writing performance. In some embodiments, if the estimated cache flush time becomes less than a minimum threshold time, then the maximum write cluster count may be increased in order to further improve the random writing performance of the device. In further embodiments, when an idle condition is detected in the device, the maximum write cluster count may be reset to its default value. From step 106, the routine 100 ends.

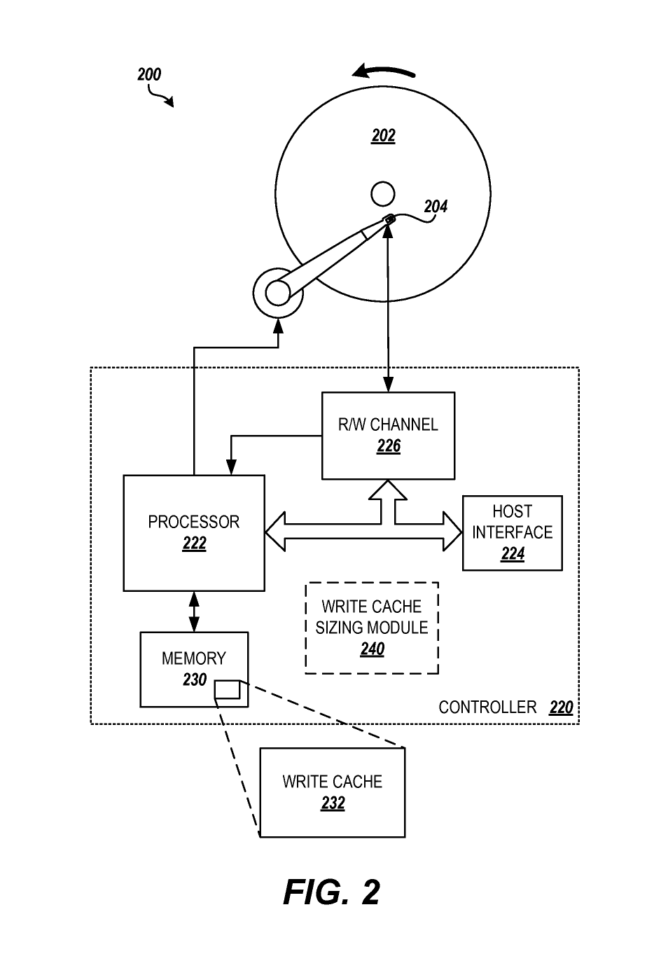

FIG. 2 and the following description are intended to provide a general description of a suitable environment in which the embodiments described herein may be implemented. In particular, FIG. 2 shows an illustrative storage device 200, such as an HDD apparatus, along with hardware, software and components for adaptively controlling the size of a write cache of the device based on the time required to flush the cache, according to the embodiments provided herein. The storage device 200 may include recording media comprising at least one platter or disk 202. Each disk 202 of the storage device may comprise one or two magnetic recording surfaces. The recording surface(s) of each disk 202 may be formatted into sectors, tracks, and zones for the storage of data.

The storage device 200 further includes at least one read/write head 204 located adjacent to the magnetic recording surface(s) of each disk 202. The read/write head 204 may read information from the disk 202 by sensing a magnetic field formed on portions of the recording surface, and may write information to the disk by magnetizing a portion of the surface. It will be appreciated by one of ordinary skill in the art that the read/write head 204 may comprise multiple components, such as one or more magneto-resistive (“MR”) or tunneling MR reader elements, an inductive writer element, a head heater, a slider, multiple sensors, and the like.

The storage device 200 may further include a controller 220 that controls the operations of the storage device. The controller 220 may include a processor 222. The processor 222 may implement an interface 224 allowing the storage device 200 to communicate with a host device, other parts of storage device 200, or other components, such as a server computer, personal computer (“PC”), laptop, notebook, tablet, game console, set-top box or any other electronics device that can be communicatively coupled to the storage device 200 to store and retrieve data from the storage device. The processor 222 may process write commands from the host device by formatting the associated data and transfer the formatted data via a read/write channel 226 through the read/write head 204 and to the surface of the disk 202. The processor 222 may further process read commands from the host device by determining the location of the desired data on the surface of the disk 202, moving the read/write head(s) 204 over the determined location, reading the data from the surface of the disk via the read/write channel 226, correcting any errors and formatting the data for transfer to the host device.

The read/write channel 226 may convert data between the digital signals processed by the processor 222 and the analog read and write signals conducted through the read/write head 204 for reading and writing data to the surface of the disk 202. The analog signals to and from the read/write head 204 may be further processed through a pre-amplifier circuit. The read/write channel 226 may further provide servo data read from the disk 202 to an actuator to position the read/write head 204. The read/write head 204 may be positioned to read or write data to a specific location on the on the recording surface of the disk 202 by moving the read/write head 204 radially across the data tracks using the actuator while a motor rotates the disk to bring the target location under the read/write head.

The controller 220 may further include a computer-readable storage medium or “memory” 230 for storing processor-executable instructions, data structures and other information. The memory 230 may comprise a non-volatile memory, such as read-only memory (“ROM”) and/or FLASH memory. The memory 230 may further comprise a volatile random-access memory (“RAM”), such as dynamic random access memory (“DRAM”) or synchronous dynamic random access memory (“SDRAM”). For example, the memory 230 may store a firmware that comprises commands and data necessary for performing the operations of the storage device 200. According to some embodiments, the memory 230 may store processor-executable instructions that, when executed by the processor 222, perform the routines 100 and 400 for adaptively controlling the size of a write cache in the storage device 200 based on the time required to flush the cache, as described herein.

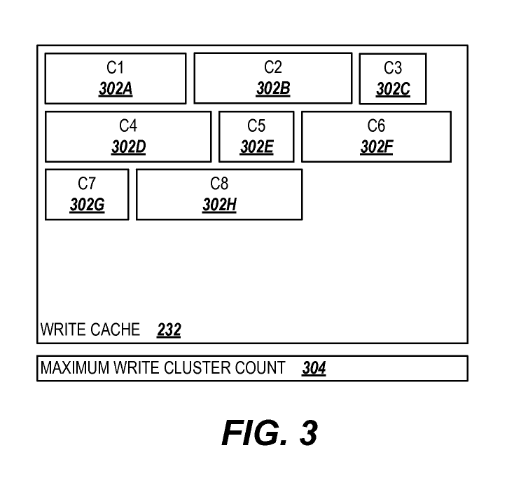

In some embodiments, the memory 230 may include a write cache 232. The processor 222 may temporarily store write data received from the host in the write cache 232 until the data contained therein may be written to the recording media. The write cache 232 may be implemented in DRAM of the controller, for example. As shown in FIG. 3, the write cache 232 may be configured to store multiple write commands or groups of commands 302A-302H (referred to herein generally as write commands 302) or “write clusters.” Further, the number of write commands 302 that may be stored in the write cache 232 may be controlled by a maximum write cluster count 304 parameter. In some embodiments, the maximum write cluster count 304 may be stored in the memory 230 of the controller. In further embodiments, the write cache 232 and the write cluster count 304 may be stored in a computing system external to and operably connected to the storage device 200, such as a cluster controller connected to a number of “dumb” disk drives or in a driver module of a host device connected to storage device through the interface 224, for example. It will be appreciated that the maximum write cluster count 304 may restrict the number of write commands 302 that may be stored in the write cache 232 such that the entire memory allocated to the write cache is not utilized.

Returning to FIG. 2, in addition to the memory 230, the environment may include other computer-readable media storing program modules, data structures, and other data described herein for adaptively controlling the size of a write cache in the storage device 200 based on time required to flush the cache. It will be appreciated by those skilled in the art that computer-readable media can be any available media that may be accessed by the controller 220 or other computing system for the non-transitory storage of information. Computer-readable media includes volatile and non-volatile, removable and non-removable recording media implemented in any method or technology, including, but not limited to, RAM, ROM, erasable programmable ROM (“EPROM”), electrically-erasable programmable ROM (“EEPROM”), FLASH memory or other solid-state memory technology, compact disc ROM (“CD-ROM”), digital versatile disk (“DVD”), high definition DVD (“HD-DVD”), BLU-RAY or other optical storage, magnetic cassettes, magnetic tape, magnetic disk storage or other magnetic storage devices and the like.

In further embodiments, the environment may include a write cache sizing module 240. The write cache sizing module 240 may calculate an estimated cache flush time for the write cache 232 based on the write commands 302 contained therein and adaptively control the maximum write cluster count 304, as described herein. According to some embodiments, the write cache sizing module 240 may be implemented in the controller 220 as software, hardware, or any combination of the two. For example, the write cache sizing module 240 may be stored in the memory 230 as part of the firmware of the storage device 200 and may be executed by the processor 222 for performing the methods and processes described herein. The write cache sizing module 240 may alternatively or additionally be stored in other computer-readable media accessible by the controller 220. In further embodiments, the write cache sizing module 240 may be implemented in a computing system external to and operably connected to the storage device 200, such as a cluster controller connected to a number of “dumb” disk drives or in a driver module of a host device connected to storage device through the interface 224, for example. The write cache sizing module 240 may further be stored in a memory or other computer-readable media accessible by the computing system and be executed by a processor of the computing system.

It will be appreciated that the structure and/or functionality of the storage device 200 may be different that that illustrated in FIG. 2 and described herein. For example, the processor 222, read/write channel 226, memory 230 and other components and circuitry of the storage device 200 may be integrated within a common integrated circuit package or distributed among multiple integrated circuit packages. Similarly, the illustrated connection pathways are provided for purposes of illustration and not of limitation, and some components and/or interconnections may be omitted for purposes of clarity. It will be further appreciated that the storage device 200 may not include all of the components shown in FIG. 2, may include other components that are not explicitly shown in FIG. 2 or may utilize an architecture completely different than that shown in FIG. 2.

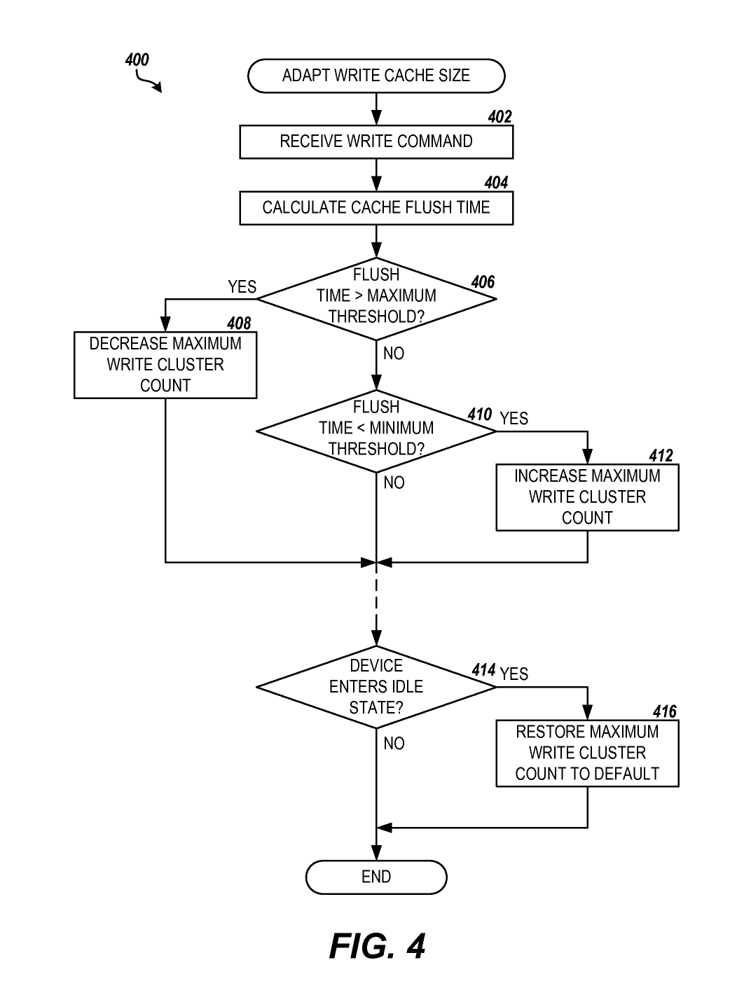

FIG. 4 illustrates another routine 400 for adaptively controlling the size of a write cache 232 in a storage device 200 based on the time required to flush the cache, according to some embodiments. In some embodiments, the routine 400 may be performed by the write cache sizing module 240 implemented in the controller 220 of the storage device 200, as described above in regard to FIG. 2. In further embodiments, the routine 400 may be performed by the processor 222 implemented in the controller 220 of the storage device 200, by a computing system external to and operably connected to the storage device, or by any combination of these and/or other components, modules, processors, and devices. The routine 400 begins at step 402, where a write operation is received by the controller 220 of the storage device 200. The write operation may be received from a connected host through the host interface 224, for example.

From step 402, the routine 400 proceeds to step 404, where the write cache sizing module 240 calculates an estimated cache flush time based on the write commands 302 currently in the write cache 232. The estimated cache flush time may be calculated based on various factors of the write commands 302 that affect the time required for the command to be completed. In some embodiments, these factors include the access time for moving the read/write head 204 over the target location of the write on the recording media, based on the seek time of the read/write head and the rotational latency of the disks 202. The access time may be further affected by whether technologies such as RPO are being utilized to process multiple write commands 302 in the write cache 232.

In further embodiments, these factors include the type of the write command 302 (e.g., random write, write-verify, RMW, etc.). For example, write-verify commands may require at least one additional disk rotation in an HDD device over a random write, while read-modify-write (“RMW”) commands may similarly require additional rotation(s) and/or processing time in the storage device. According to one example, in an HDD with an average seek time of 10.5 ms and a rotation time of 11 ms, a cluster write may typically take 16 ms (10.5 ms seek time+5.5 ms average latency). A write-verify may require 27 ms on average (16 ms write+11 ms for additional rotation). Similarly, a RMW command may average 27 ms (16 ms write+11 ms for additional rotation) while a RMW write with verify may require 38 ms (16 ms write+22 ms for two additional rotations.) In this example, the estimated cache flush time may be calculated by using the formula:

Flush Time=(16 ms×total cluster count)+(11 ms×(total RMW count+total verify count))

The calculation of the estimated cache flush time may also be based on other device conditions, such as temperature conditions, shock or noise environment, power conditions of the device, and the like. According to some embodiments, the extent that each of these factors affect the time of operation of the various write commands may be determined by experimentation for a particular storage device 200, or for a particular model or class of storage devices. For example, a number of random write tests may be simulated or performed in the storage device 200 during design time or during certification processing of the device, and the results used to adjust parameter values and coefficients used by the device to calculate the estimated cache flush time.

The routine 400 proceeds from step 404 to step 406, where the write cache sizing module 240 determines whether the estimated cache flush time is greater than a maximum flush time threshold. According to some embodiments, the maximum flush time threshold may be set at design time of the storage device, based on manufacturer or customer requirements for example. In some embodiments, the maximum threshold time may be between 3 and 5 seconds. In further embodiments, the maximum threshold time may be adjusted based on current conditions of the storage device 200. For example, if power supplied to the storage device 200 is below a threshold level, or if the device is in a shock or noise condition, then the maximum threshold time may be adjusted downward to limit the possibility of aborted writes in these conditions.

If the estimated cache flush time is greater than the maximum threshold time, the routine 400 proceeds from step 406 to step 408, where the write cache sizing module 240 decreases the maximum write cluster count 304. According to some embodiments, the maximum write cluster count 304 may be decreased gradually while the estimated cache flush time remains above the maximum threshold time. For example, the maximum write cluster count 304 may be reduced by a pre-defined amount, such as 5, each time a write command is received and it is determined that the estimated cache flush time exceeds the maximum threshold. In other embodiments, the reduction to the maximum write cluster count 304 may depend on the difference between the estimated cache flush time and the maximum threshold time.

If the estimated cache flush time is not greater than the maximum threshold time, the routine 400 proceeds from step 406 to step 410, where the write cache sizing module 240 determines whether the estimated cache flush time is less than a minimum flush time threshold, according to some embodiments. As in the case of the maximum threshold time, the minimum flush time threshold may be set at design time of the storage device, or may be adjusted based on current conditions of the storage device 200. In some embodiments, the minimum threshold time may be 1 or 2 seconds.

If the estimated cache flush time is less than the minimum threshold time, the routine 400 proceeds from step 410 to step 412, where the write cache sizing module 240 increase the maximum write cluster count 304. Similarly to step 408 described above, the maximum write cluster count 304 may be increased gradually while the estimated cache flush time remains below the minimum threshold time. For example, the maximum write cluster count 304 may be increased by a pre-defined amount, such as 5, each time a write command is received and it is determined that the estimated cache flush time is below the minimum threshold time.

Additionally or alternatively, the maximum write cluster count 304 may be adjusted based on other conditions of the storage device 200, such as temperature conditions, shock or noise environment, power conditions of the device, and the like, according to some embodiments. For example, each time a write command is received, if a shock condition or nFAULT (power) condition is detected in the storage device 200, the write cache sizing module 240 may gradually decrease the maximum write cluster count 304 by the pre-defined amount. Once the condition is cleared, the write cache sizing module 240 may gradually increase the maximum write cluster count 304 by the pre-defined amount until it has returned to the appropriate value (e.g., based upon the estimated cache flush time).

According to further embodiments, the write cache sizing module 240 may further detect that the storage device 200 has entered the idle state, as shown at step 414 in FIG. 4. For example, no current write command is pending. If the write cache sizing module 240 detects that the storage device 200 has entered the idle state, the routine 400 may proceed from step 414 to step 416, where the write cache sizing module 240 restores the maximum write cluster count 304 to its initial, default value. From step 416, the routine 400 ends.

Based on the foregoing, it will be appreciated that technologies for adaptively controlling the size of a write cache in a storage device based on the time required to flush the cache are presented herein. While embodiments are described herein in regard to an HDD device, it will be appreciated that the embodiments described in this disclosure may be utilized in any storage device in incorporating a write cache that may be affected by sudden power loss, including but not limited to, a magnetic disk drive, a hybrid magnetic and solid state drive, a magnetic tape drive, an optical disk storage device, an optical tape drive and the like. The above-described embodiments are merely possible examples of implementations, merely set forth for a clear understanding of the principles of the present disclosure.

The logical steps, functions or operations described herein as part of a routine, method or process may be implemented (1) as a sequence of processor-implemented acts, software modules or portions of code running on a controller or computing system and/or (2) as interconnected machine logic circuits or circuit modules within the controller or computing system. The implementation is a matter of choice dependent on the performance and other requirements of the system. Alternate implementations are included in which steps, operations or functions may not be included or executed at all, may be executed out of order from that shown or discussed, including substantially concurrently or in reverse order, depending on the functionality involved, as would be understood by those reasonably skilled in the art of the present disclosure.

It will be further appreciated that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

Many variations and modifications may be made to the above-described embodiments without departing substantially from the spirit and principles of the present disclosure. Further, the scope of the present disclosure is intended to cover any and all combinations and sub-combinations of all elements, features and aspects discussed above. All such modifications and variations are intended to be included herein within the scope of the present disclosure, and all possible claims to individual aspects or combinations of elements or steps are intended to be supported by the present disclosure.

What is claimed is:

1. A method comprising steps of:
receiving a write command at a controller for a storage device;
calculating, by the controller, an estimated cache flush time for a write cache for the storage device;
determining, by the controller, whether the estimated cache flush time is greater than a maximum threshold time; and
upon determining that the estimated cache flush time is greater than the maximum threshold time, decreasing, by the controller, a size of the write cache.

2. The method of claim 1, further comprising:
determining, by the controller, whether the estimated cache flush time is less than a minimum threshold time; and
upon determining that the estimated cache flush time is less than the minimum threshold time, increasing, by the controller, the size of the write cache.

3. The method of claim 1, further comprising:
detecting, by the controller, that the storage device has entered into an idle state; and
upon detecting that the storage device has entered into the idle state, resetting the size of the write cache to an initial, default size.

4. The method of claim 1, wherein increasing the size of the write cache comprises increasing a maximum write cluster count indicating a number of random write commands that may be stored in the write cache.

5. The method of claim 1, wherein calculating the estimated cache flush time comprises estimating an access time for each write command in the write cache.

6. The method of claim 1, wherein calculating the estimated cache flush time comprises determining a type of each write command in the write cache.

7. The method of claim 6, wherein the types of the write commands in the write cache comprise random write commands, write-verify commands, and read-modify-write commands.

8. The method of claim 1, wherein calculating the estimated cache flush time comprises determining environmental conditions of the storage device.

9. The method of claim 1, wherein the controller is contained within the storage device.

10. The method of claim 1, wherein the write cache is contained in a dynamic random-access memory (“DRAM”) of the controller.

11. A system for storing data comprising:
a storage device comprising a recording medium;
a write cache for temporarily storing write commands received for the storage device before processing; and
a controller for processing the write commands, the controller configured to
calculate an estimated cache flush time for the write cache,
determine whether the estimated cache flush time is greater than a maximum threshold time,
upon determining that the estimated cache flush time is greater than the maximum threshold time, decrease a maximum write cluster count indicating a number of write commands that may be stored in the write cache,
upon determining that the estimated cache flush time is not greater than the maximum threshold time, determine whether the estimated cache flush time is less than a minimum threshold time, and
upon determining that the estimated cache flush time is less than the minimum threshold time, increase the maximum write cluster count.

12. The system of claim 11, wherein the controller is further configured to
detect that the storage device has entered into an idle state; and
upon detecting that the storage device has entered into the idle state, reset the maximum write cluster count to an initial, default value.

13. The system of claim 11, wherein the maximum write cluster count is increased and decreased by a pre-defined amount.

14. The system of claim 11, wherein calculating the estimated cache flush time comprises estimating an access time for each write command in the write cache.

15. The system of claim 11, wherein calculating the estimated cache flush time comprises determining a type of each write command in the write cache.

16. The system of claim 11, wherein the write cache is contained in a memory of the controller.

17. A non-transitory computer-readable medium containing processor-executable instructions that, when executed by a processor operably connected to a storage device, cause the processor to:
receive a write command for the storage device;
calculate an estimated cache flush time for a write cache for the storage device;
determine whether the estimated cache flush time is greater than a maximum threshold time;
upon determining that the estimated cache flush time is greater than the maximum threshold time, decrease a maximum write cluster count indicating a number of write commands that may be stored in the write cache;
upon determining that the estimated cache flush time is not greater than the maximum threshold time, determine whether the estimated cache flush time is less than a minimum threshold time; and
upon determining that the estimated cache flush time is less than the minimum threshold time, increase the maximum write cluster count.

18. The computer-readable medium of claim 17, containing further processor-executable instructions that cause the processor to:
detect that the storage device has entered into an idle state; and
upon detecting that the storage device has entered into the idle state, reset the maximum write cluster count to an initial, default value.

19. The computer-readable medium of claim 17, wherein calculating the estimated cache flush time comprises estimating an access time for each write command in the write cache.

20. The computer-readable medium of claim 17, wherein calculating the estimated cache flush time comprises determining a type of each write command in the write cache.
